(19) United States
(12) Patent Application Publication
(10) Pub. No.: US 2005/0029281 A1
(43) Pub. Date: Feb. 10, 2005

(54) Trash container bag dispenser

(76) Inventors: Werner Westermann, Buellton, CA (US); John F. Padilla, Santa Barbara, CA (US)

Correspondence Address: G. F. Gallinger, 7420 Milner Dr., Colorado Springs, CO, 80920, US

(21) Appl. No.: 10/636,958

(22) Filed: Aug. 8, 2003

(51) Int. Cl. G07F 11/00; B65G 59/00

(52) U.S. Cl. 221/199

(57) ABSTRACT

A trash bag dispenser which can be universally fitted within any trash container having a generally flat central bottom portion. The dispenser is also removable from the trash container to replace the roll of bags and to clean the trash container. A single bag is individually dispensed within the trash container from a roll of bags. The dispenser comprises: a housing to hold the roll of trash bags, said housing having a lower side portion, an upright side wall, and an upper side portion having a bag dispensing opening therein; and, a removable and reattachable housing attachment strip to facilitate removable and reattachable attachment of the housing to the trash container. After a first bag is pulled from the trash bag dispenser, subsequent bags are automatically pulled therefrom when a preceding bag is filled and removed from the trash container. Most preferably, the attachment strips comprise mated self adhering hook and loop strips such as those sold under the TM VELCRO.

### FIELD OF THE INVENTION

This invention relates to trash bags used in trash containers. More particularly this invention relates to a convenient apparatus and method of dispensing and positioning empty trash bags within a trash container.

### BACKGROUND OF THE INVENTION

In most residences trash bags are removed when they are full. After the trash is removed a new trash bag must be found so that it may be positioned in the trash container. In most institutions and corporations trash bags are replaced on a scheduled cleaning cycle. The frequency of trash bag removal and replacement must be sufficient to ensure that even during periods of heavy use that collected trash is removed before the trash container is full. Empty trash bags are not generally available to users. Trash bags are usually removed and replaced by cleaning personnel when they are substantially less than half full.

To minimize time consumed in obtaining and replacing trash bags, and to promote complete and efficient use of trash bags, a trash bag dispenser which automatically replaces trash bags is needed. Most preferably, the trash bag dispenser should allow an existing trash container to be retrofitted. And most importantly, the trash bag container must be easily and completely removable from the trash container to facilitate intermittent cleaning in the event of trash bag breakage. Removal also facilitates replacement of bags within the trash bag dispenser. Finally, the trash bag dispenser should be sufficiently substantial so that it will not collapse when it bears the weight of a heavily loaded bag of trash. It is necessary that a trash bag be able to be dispensed when a fully loaded bag of trash is supported by the trash dispenser positioned in the bottom of the trash container.

### OBJECTS OF THE INVENTION

It is an object of this invention to disclose an apparatus which can be retrofitted within an existing trash container to dispense trash bags therefrom. It is an object of this invention to disclose a method of universally attaching the. trash bag dispenser to any existing trash container. It is yet a further object of this invention to disclose a method of removably attaching a trash bag dispenser to a trash container so that the trash dispenser can be removed to clean the trash container or to replace the trash bags within the trash dispenser when the trash bags therein have all been dispensed. The ability to readily remove the dispenser from the trash container is essential in the event of a broken trash bag, or when the trash container is too high to readily reach into and manipulate directly above a bottom side portion thereof. It is a final object of this invention to disclose a trash bag dispenser which can be conveniently refilled with trash bags.

One aspect of this invention provides for a trash bag dispenser to dispense a single bag from a roll of bags within a trash container having a generally flat central interior bottom side portion comprising: a housing to hold the roll of trash bags having a lower side portion, an upright side wall, and an upper side portion having a bag dispensing opening therein; and, a removable and reattachable housing attachment means to facilitate removable and reattachable attachment of the housing to the generally flat central interior bottom side portion of the trash container. After a first bag is pulled from the trash bag dispenser, subsequent bags are automatically pulled therefrom when a preceding bag is filled and removed from the trash container; and, the trash bag dispenser is removable to replace the roll of bags and to clean the trash container.

In a preferred aspect of this apparatus the removable and reattachable housing attachment means comprises mated self adhesive hook and loop attachment strips do that the trash bag dispenser may be releasably secured to any trash container having a generally flat central interior bottom side portion.

A method of automatically dispensing a single trash bag from a roll of trash bags from within a trash container having a generally flat central interior bottom side portion comprising the following steps: providing a trash bag housing to hold the roll of bags, said housing having a lower side portion, an upright side wall, and an upper side portion having a bag dispensing opening therein; providing mated hook and loop attachment strips and attaching one of the strips to an exterior of the lower side portion of the housing, and the other mated strips to the generally flat central interior side portion of the trash container; so that when the housing is releasably attached to the bottom side portion of the trash container, successive bags are automatically pulled out from within the container when a first bag is removed from the container; and, so that the housing may be removed from the container to replace the roll of trash bags and to clean the container.

Various other objects, advantages and features of this invention will become apparent to those skilled in the art from the following description in conjunction with the accompanying drawings.

### FIGURES OF THE INVENTION

FIG. 1 is a perspective view of a trash container having a trash bag dispenser removably mounted on an interior bottom side portion of the trash container.

FIG. 2 is an enlarged perspective view of the trash bag dispenser shown in FIG. 1. The trash bag dispenser is shown in an open position.

The following is a discussion and description of the preferred specific embodiments of this invention, such being made with reference to the drawings, wherein the same reference numerals. are used to indicate the same or similar parts and/or structure. It should be noted that such discussion and description is not meant to unduly limit the scope of the invention.

### DESCRIPTION OF THE INVENTION

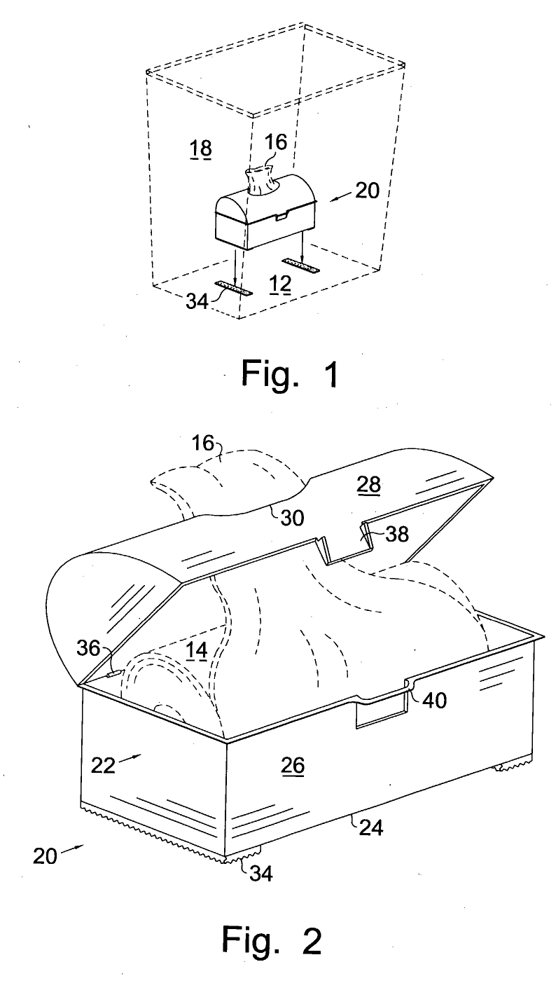

Turning now to the drawings and more particularly to FIG. 1 we have a perspective view of a trash container 18 having a trash bag dispenser 20 removably mounted on an interior bottom side portion of the trash container 20. FIG. 2 is an enlarged perspective view of the trash bag dispenser 20 shown in FIG. 1. In FIG. 2 the trash bag dispenser 20 is shown in an open position. The trash bag dispenser 20 dispenses a single bag 16 from a roll of bags 14 within the trash container 18. The trash container 18 has a generally flat central interior bottom side portion 12. The trash bag dispenser 20 holds the roll of trash bags 14 within a housing 22 having a bottom side portion 24, an upright side wall 26, and a top side portion 28 having a bag dispensing opening 30 therein. A removable and reattachable housing attachment means 32 facilitates removable and reattachable attachment of the housing 22 to the generally flat central interior bottom side portion 12 of the trash container 18. After a first bag 16 is pulled from the trash bag dispenser 20, subsequent bags on the roll 14 are automatically pulled therefrom when a preceding bag is filled and removed from the trash container 18. The trash bag dispenser 20 is removable to replace the roll of bags 14 and to clean the trash container 20.

Most preferably, the top side portion 28 of the housing 22 is adapted to open and close, and thereby facilitate insertion and positioning of the roll of bags 14 therein. If the housing 22 is sufficiently rigid and rugged it can then uphold a fully filled trash bag 16 without collapsing and thereby ensure that the roll of bags 14 can rotate to individually discharge bags 16.

In the most preferred embodiment of the invention, the removable and reattachable housing attachment means comprises mated self adhesive hook and loop attachment strips 34. With these strips 34 the trash bag dispenser 20 may be releasably secured to any trash container 18 having a generally flat central interior bottom side portion 12. These strips 34 are similar to those marketed under the trade mark VELCRO.

In the most preferred embodiment of the invention the housing 22 generally has the shape of a rectangular box. The housing 22 is molded from plastic and the top side portion 28 thereof is hinged 36 to an upright side portion 26 thereof. An upright side portion 26 of the housing 22 opposite to the hinged side is provided with a releasable molded plastic clasp 38 and clasp retainer 40.

A method of automatically dispensing a single trash bag 16 from a roll of trash bags 14 from within a trash container 18 having a generally flat central interior bottom side portion 12 comprises the following steps: providing a trash bag housing 22 to hold the roll of bags 14, said housing 22 having a lower side portion 24, an upright side wall 26, and an upper side portion 28 having a bag dispensing opening 30 therein; and, providing mated hook and loop attachment strips 34 and attaching one of the strips 34 to an exterior of the.lower side portion 24 of the housing 22, and the other mated strip to the generally flat central interior side portion 12 of the trash container 18. When the housing 22 is releasably attached to the bottom side portion 12 of the trash container 18 then successive bags are automatically pulled out from within the container 18 when a first bag 16 is removed from the container 18; and, the housing 22 may be removed from the container 18 to replace the roll of trash bags 14 and to clean the container 18.

Most preferably, 2 VELCRO TM strips 34 are attached, one at each end of the exterior bottom side portion, to the trash bag dispenser 20. When a full trash bag 16 is pulled out of the trash container 18, the full bag 16 must be separated from the next (empty) bag, and then the top portion of the empty bag 16 must be folded over the top portion of the trash container 18. The bag dispenser 20 has been constructed in many sizes to accomodate different bag and trqsh can sizes.

While the invention has been described with preferred specific embodiments thereof, it will be understood that this description is intended to illustrate and not to limit the scope of the invention, which is defined by the following claims.

1) A trash bag dispenser to dispense a single bag from a roll of bags within a trash container having a generally flat central interior bottom side portion comprising:
a housing to hold the roll of trash bags having a lower side portion, an upright side wall, and an upper side portion having a bag dispensing opening therein; and, a removable and reattachable housing attachment means to facilitate removable and reattachable attachment of the housing to the generally flat central interior bottom side portion of the trash-container;
so that after a first bag is pulled from the trash bag dispenser, subsequent bags are automatically pulled therefrom when a preceding bag is filled and removed from the trash container; and,
so that the trash bag dispenser is removable to replace the roll of bags and to clean the trash container.

2) A dispenser as in claim 1 wherein the top side portion of the housing is adapted to open and close, and thereby facilitate insertion and positioning of the roll of bags therein.

3) A dispenser as in claim 2 wherein the housing is sufficiently rigid and rugged to uphold a fully filled trash bag without collapsing and thereby ensure that the roll of bags can rotate to individually discharge bags.

4) A dispenser as in claim 1 wherein the removable and reattachable housing attachment means comprises mated self adhesive hook and loop attachment strips do that the trash bag dispenser may be releasably secured to any trash container having a generally flat central interior bottom side portion.

5) A dispenser as in claim 2 wherein the housing generally has the shape of a rectangular box.

6) A dispenser as in claim 5 wherein the housing is made from molded plastic and wherein the top side portion thereof is hinged to an upright side portion thereof.

7) A dispenser as in 6 wherein an upright side of the housing, opposite to the hinged side, is provided with a releasable molded plastic clasp and clasp retainer.

8) A method of automatically dispensing a single trash bag from a roll of trash bags from within any trash container having a generally flat central interior bottom side portion comprising the following steps:
providing a trash bag housing to hold the roll of bags, said housing having a lower side portion, an upright side wall, and an upper side portion having a bag dispensing opening therein;
providing mated hook and loop attachment strips and attaching one of the strips to an exterior of the lower side portion of the housing, and the other mated strips to the generally flat central interior side portion of the trash container;
so that when the housing is releasably attached to the bottom side portion of the trash container, successive bags are automatically pulled out from within the container when a first bag is removed from the container; and,
so that the housing may be removed from the container to replace the roll of trash bags and to clean the container.

9) A method as in claim 8 wherein the top side portion of the housing is adapted to open and close to thereby facilitate insertion and positioning of the roll of bags therein.

10) A method as in claim 9 wherein the housing is sufficiently rigid and rugged to uphold a fully filled trash bag without collapsing and thereby ensure that the roll of bags can rotate to individually discharge bags.

11) A method as in claim 9 wherein the housing generally is made in the shape of a rectangular box.

12) A method as in claim 11 wherein the housing is made from molded plastic and wherein the upper side portion thereof is hinged to an upright side portion thereof.

13) A method as in 12 wherein an upright side of the housing, opposite to the hinged side, is provided with a releasable molded plastic clasp and clasp retainer.
